(19) United States
(12) Patent Application Publication
(10) Pub. No.: US 2003/0231339 A1
(43) Pub. Date: Dec. 18, 2003

(54) Remote printing system and remote printing service method

(75) Inventors: Shinji Makishima, Tokyo (JP); Kazuhiro Ogura, Yokohama-shi (JP); Hiroshi Yamaguchi, Tagata-gun (JP); Hiroshi Yamamoto, Toda-shi (JP); Keishi Higashi, Tokyo (JP)

Correspondence Address: FOLEY AND LARDNER, SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/446,936

(22) Filed: May 29, 2003

(30) Foreign Application Priority Data
May 31, 2002 (JP) 2002-159680

(51) Int. Cl. B41B 1/00; G06K 1/00; G06F 15/00

(52) U.S. Cl. 358/1.15; 358/1.13

(57) ABSTRACT

The present invention is to improve the usability and the convenience. A remote printing system comprises a remote printing server for receiving registration of printing subject data to be printed from a communication terminal operated by a user for printing the printing subject data from a predetermined printing terminal distributed and installed in a wide area, wherein the communication terminal comprises a data format converting section for converting the data format of the printing subject data to the data format handled by the remote printing server, and a communication section for transmitting the printing subject data after the conversion and requesting the registration, and the printing terminal comprises a printing outputting section for executing the printing output according to the data format handled by the remote printing server.

### BACKGROUND OF THE INVENTION

1. Field of the Invention

The present invention relates to a remote printing system and remote printing service method, which are suitably used in the case of for example executing printing output by an MMK (multimedia kiosk) terminals, or the like distributed and installed in a wide area via Internet, or the like.

2. Description of the Related Art

Conventionally, in the case printing output is desired outside the office or the house, the desired printing output can be obtained at a place where a printer unit is installed (business convenience store, or the like).

However, since the density of the business convenience stores or the like is not always high, the printing output cannot be executed immediately in the case when the printing output is needed, and furthermore, search of a shop is troublesome as well.

Moreover, since the data format to be processed differs depending on the kind of the printer units, a driver corresponding to the data format of the printer unit should be installed in a laptop personal computer having stored therein the electronic data to be printed, or the like. Such installation itself is time taking and labor taking so as to pose the burden on the user. Furthermore, repetition of installation of drivers different for each kind consumes the memory capacity of the hard disc of the laptop personal computer, or the like, and thus it is disadvantageous.

Moreover, even in the case a user finds a page to be printed while viewing a Web page, since a business convenience store may not be found or installation of a driver is required, the actual execution of the printing output can be much later than the time of finding the Web page to be printed in many cases so that the URL of the Web page needs to be memorized in a laptop personal computer or memorized in his/her own memory, and thus it is not usable and not convenient.

Although an example of the outside is presented here, the same problem can arise even when it is not the outside such as when there is not a printer unit in the house, or the like.

### SUMMARY OF THE INVENTION

In order to solve the problems, according to a first aspect of the present invention, there is provided a remote printing system comprising a remote printing server (such as a virtual printing server) for accepting registration of printing subject data to be printed from a communication terminal (such as a laptop personal computer) operated by a user for printing the printing subject data from a predetermined printing terminal (such as an MMK terminal) distributed and installed in a wide area, wherein the communication terminal comprises: a data format converting section for converting the data format of the printing subject data to the data format (such as a DM1) handled by the remote printing server; and a communication section for transmitting the printing subject data after the conversion and requiring the registration (such as a wireless LAN adopter and a file registering module 34), and the printing terminal comprises a printing output section for executing the printing output according to the data format handled by the remote printing server.

Moreover, according to a second aspect of the present invention, there is provided a remote printing service method using a remote printing server for receiving registration of printing subject data to be printed from a communication terminal operated by a user for printing the printing subject data from a predetermined printing terminal distributed and installed in a wide area, wherein a data format converting section converts the data format of the printing subject data to the data format handled by the remote printing server, and a communication section transmits the printing subject data after the conversion and requires the registration in the communication terminal, and a printing output section executes the printing output according to the data format handled by the remote printing server in the printing terminal.

Therefore, according to the first and second aspects of the present invention, since a user using the communication terminal with respect to the remote printing server functioning in a wide area distributed environment, can basically always register the printing subject data of the data format handled by the remote printing server, for example even in the case the printing subject data is a Web page during viewing, the URL thereof needs not be memorized in the communication terminal or memorized in his/her own memory.

### BRIEF DESCRIPTION OF THE DRAWINGS

FIG. 1 is a schematic chart showing a configuration example of the principal part of a laptop personal computer to be used in first and second embodiments;

FIG. 2 is a schematic chart showing an entire configuration example of a mobile printing system of the first and second embodiments;

FIG. 3 shows an example of the display screen in the first and second embodiments;

FIG. 4 is an operation explanatory chart of the first and second embodiments;

FIG. 5 is an operation explanatory chart of the first and second embodiments;

FIG. 6 is an operation explanatory chart of the first and second embodiments;

FIG. 7 shows an example of the display screen in the first and second embodiments;

FIG. 8 is a schematic chart showing a configuration example of the principal part of an administration module used in a laptop personal computer of the first and second embodiments;

FIG. 9 is a schematic chart showing a configuration example of the principal part of a mobile printing system of the second embodiment;

FIG. 10 is an operation explanatory chart of the second embodiment; and

FIG. 11 shows an example of the display screen in the second embodiment.

### DETAILED DESCRIPTION OF THE PREFERRED EMBODIMENTS

(A) Embodiments

Hereinafter, embodiments of a remote printing system and a remote printing service method of the present invention will be explained in an example of the case used in a mobile environment.

(A-1) Configuration of a First Embodiment

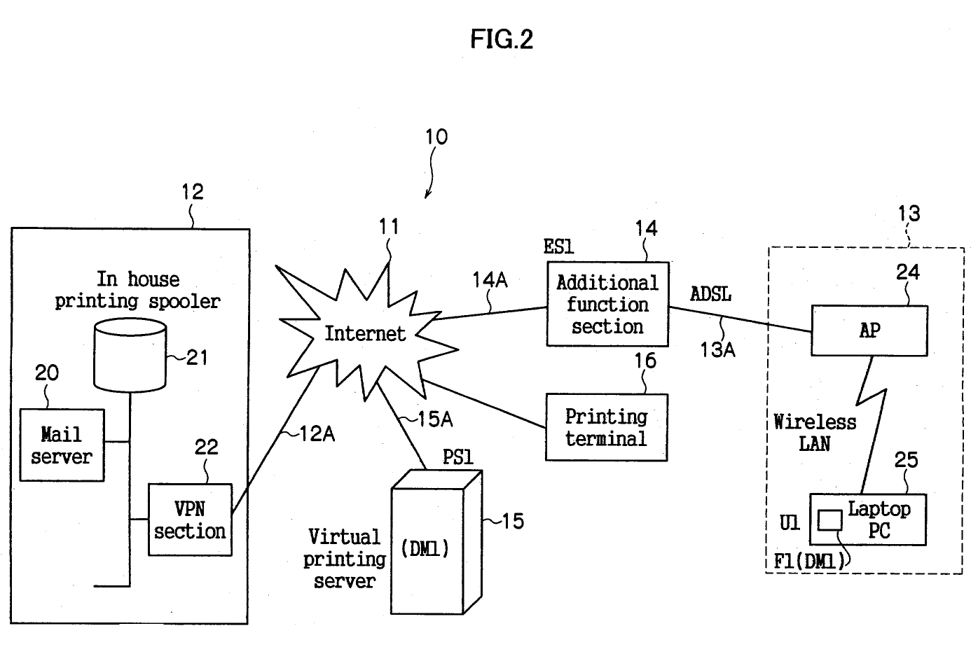

The entire configuration example of a mobile printing system 10 of this embodiment is shown in FIG. 2.

In FIG. 2, the mobile printing system 10 comprises an internet 11, an intranet 12, a provided wireless LAN 13, an additional function section 14, a virtual printing server 15, and a printing terminal 16.

Among them, in the intranet (in-house LAN (local area network)) 12, a mail server 20, an in-house printing spooler 21, a VPN (Virtual Private Network) section 22, or the like are provided. A user U1 having a laptop PC (laptop personal computer) 25, a worker of a company establishing and utilizing the intranet 12, has his own mail box in the mail server 20.

The in-house printing spooler 21 has a function of temporarily accumulating a printing subject file F1 (DM1) requested by the user U1 for registration in the virtual printing server 15, using the laptop personal computer 25 from inside or outside the intranet 12, and transmitting the printing subject file F1 (DM1) after the accumulation to the virtual printing server 15 for requesting the registration thereof.

In the case the user U1 requests printing from inside the intranet 12, the user U1 returned from the outside to the company connects the laptop personal computer 25 with the intranet 12 by wire or wireless so as to transmit the printing subject file F1 (DM1) to the in-house printing spooler 21. Here, F1 (DM1) represents the file obtained by receiving the registration of a printing subject file F1 of an optional data format by the virtual printing server 15, and converting the same into a processable data format DM1.

As specific examples of the data format DM1, for example, PDF, SVG, PS, TIFF, JPEG, GIF, PCL, a predetermined vector description language, or the like can be used.

In contrast, in the case the user U1 requests printing from outside the intranet 12, the printing subject file F1 (DM1) is conveyed to the in-house printing spooler 21 byan electronic mail or an XML file, utilizing the access resource providing service to be described later from the outside. The printing subject file F1 (DM1) is conveyed as the XML file in the case a SOAP protocol is utilized. The SOAP protocol enables a remote procedure call (RPC) beyond the fire wall, utilizing the HTTP protocol.

For conveying the printing subject file F1 (DM1) from the outside of the intranet 12 to the in-house printing spooler 21, utilizing the electronic mail, a mechanism for linking the mail server 20 and the in-house printing spooler 21 is needed.

The linkage mechanism may be for example, one recognizing an electronic mail requiring accumulation of the printing subject file F1 (DM1) in the in-house printing spooler 21, using a specific mail box of the mail server 20, or using information of each field of the mail headers of the electronic mail, or the like.

The specific mail box can be regarded as a mail box provided for the linkage for requesting accumulation in the in-house printing spooler 21 at the time of receiving an incoming message to the mail box (that is, requesting registration of the printing subject file to the virtual printing server 15). Moreover, in the case information of each field of the mail header of the electronic mail is used, in order to judge whether or not it is for requesting accumulation to the in-house printing spooler 21 from the information content of each field, the mail box for receiving the electronic mails can be anyone. For example, it may be the own mail box of the user U1.

In the case the linkage mechanism recognizes an electronic mail for requesting accumulation to the in-house printing spooler 21, the printing subject file F1 (DM1) of the electronic mail is automatically accumulated in the in-house printing spooler 21.

In general, at the time of utilizing an electronic mail, the printing subject file F1 (DM1) is added to the electronic mail in the form of an affixed file.

The in-house printing spooler 21 may be provided with a function of storing an access log concerning a worker using itself (for example, U1).

Although it is not shown in FIG. 2, in the case an RAS (Remote Access Server) is provided in the intranet 12, the printing subject file F1 (DM1) may be provided from the laptop personal computer 25 outside the intranet 12 to the in-house printing spooler 21 according to the remote access via a PHS network, or the like.

Naturally, as needed, the printing subject file F1 (DM1) may be registered directly in the virtual printing server 15 from the laptop personal computer 25 via the provided wireless LAN 13 and the internet 15 without passing through the in-house printing spooler 21.

The above-mentioned access resource providing service is a service for enabling the access to the internet 11 by providing the wireless LAN (or wired LAN, however, it is a wireless LAN in this embodiment) to a large number of specific (or unspecific) users. For the access of the user to the internet 11, the access line band for connecting the provided wireless LAN 13 and the internet 11 is consumed physically by the communication of the communication terminal (here, the laptop personal computer 25) operated by the user, and therefor, the configuration information such as the private IP address should be allocated to the communication terminal by the DHCP server (the DHCP server function can be provided in a router (in the case of a wireless LAN, it is a wireless router)) on the provided wireless LAN 13 side as the premise.

Therefore, the access resource provided from the access resource providing service to the user includes not only the physical access line band, but also various kinds of physical and logical resources such as the wireless propagation path in the LAN, and the above-mentioned logical configuration information.

Details of the access resource providing service are varied both from the business model viewpoint and from the realization technique viewpoint. Since it is a service of a new type, the content thereof may change in the future with high possibility. In the case of the wireless LAN, it is substantially common to the service providing agents that the electric waves in a 2.4 GHz band is utilized, that the size of the area covered by a service providing agent (one access point (AP)) is limited at most in a circle of about a 50 m radius (however, it is in the case of inside a room, and in the case of an open space without an obstacle blocking the electric wave, the radius can be at most about 200 m), that a plurality of service providing agents can hardly set those cover areas at the same time practically, that the access line to be used is a broad band, that the DHCP is utilized, that a mechanism linking the service providing agents does not exist, or the like.

Depending on the service providing agents, the service is chargeable or free. In the case it is chargeable, since a user needs to be registered preliminarily as a member so that the user authentication is executed each time the user utilizes the access resource providing service, the service is provided for a specific large number of people. In the case it is free, since anyone can utilize the service as long as one has a communication terminal comprising a DHCP client function or a network function (for example, an ordinary laptop personal computer comprising a wireless LAN adopter (LAN card for a wireless LAN) has all the functions), the service is provided for an unspecific large number of people.

A wired LAN propagation medium, that is, a wired propagation path can be used for the propagation path for connecting the laptop personal computer and the router can be used. However, at a highly public space such as a station, a park, a hotel lobby, town corners, or the like, a wireless propagation path is used frequently as the LAN propagation medium as in this embodiment.

As to the access line with respect to the internet 11, a wired line such as the ADSL can often be utilized, but in the case of the FWA, the access line is wireless as well.

In the example of FIG. 2, the ADSL is used as the access line 13A (, 14A), and the LAN propagation medium for connecting the access point (AP) 24 and the laptop personal computer 25 is a wireless propagation path.

A wireless router, or one or a plurality of wireless access point devices to be disposed under the wireless router can correspond to the access point. In this case, the cover area of the service providing agent should be one corresponding to the cover areas of all the access points (wireless routers and wireless access point devices (however, in the case a wireless access point device is used, the router needs not always be wireless)). However, partially due to the need of coping with the problems of hand over, or the like, it may be a complicated system configuration so that most service providing agents execute the access resource providing service using only one access point in the present situation.

The additional function section 14 operated by the service providing agent ES1 shown in FIG. 2 is a section having the function of the above-mentioned user authentication, or the like. Therefore, in the case of providing the service for free, the additional function section 14 can be omitted.

As shown in FIG. 2, the additional function section 14 can be disposed to the user U1 side with respect to the access line, but it can also be provided on the internet 11 (for example, in the ISP Internet Service Provider) network).

The virtual printing server 15 temporarily stores the content of the printing subject file at the time of receiving a request for registration of a printing subject file (for example, F1 (DM1)) via the internet 11, and it transmits the printing subject file via the internet 11 when it receives a request (printing output request) from a user via the internet 11 to the corresponding printing terminal 16 so as to print and output the printing subject file from the printing terminal 16. The printing subject file data format to have registration by the virtual printing server 15 and processed thereby is limited to the specific data format DM1.

The printing terminal 16 may be an MMK terminal, or the like installed with a high density at a place to have a large number of people gathered, such as a convenience store and a station. The MMK terminal can provide the printer function by storing a printer function in itself or by being connected with an external printer unit. The geographical area to have the printing terminal 16 installed is distributed in a wide area such as the entire area of an urban part, or the entire area of a plurality of urban areas in the country, or the like.

Since a registration request and a printing output request of the printing subject file (such as F1 (DM1)) can be executed via the internet 11, extremely high convenience can be obtained as if the printing terminal (high performance printer terminal) 16 is mounted in the laptop personal computer 25 itself.

In this embodiment, the virtual printing server 15 receives a file registration request for print and output from the printing terminal 16 only for the preliminarily registered members.

The VPN section 22 has a point function for realizing the VPN. Such a point function can be provided in a form of a VPN device as a dedicated device, or in a form of an additional function of a fire wall. In this embodiment, the VPN section 22 is mounted in the fire wall as an additional function.

The fire wall controls the access between the intranet 12 and the internet 11 for preventing an unauthorized access from the internet 11 to the intranet 12, and for allowing access from the intranet 12 to the internet 11. The fire wall has also a proxy server function. The proxy server relays communication inside and outside the intranet 12 by interpreting the protocols of the upper hierarchy with respect to the transport layer of the OSI reference model.

The VPN section 22 forms a virtual closed area network on the internet 11 using an IP sec protocol. In the case the laptop personal computer 25 transmits the above-mentioned electronic mail to the intranet 12 via the internet 11, or transmits the above-mentioned XML file, a virtual closed area network is formed by the end-end according to the VPN function (not shown) on the laptop personal computer 25 side and the VPN function of the VPN section 22. In the case the virtual closed area network is formed by the end-end, not only tapping of the information, or the like on the internet 11 can be prevented but also tapping, altering and guising of the information from the wireless propagation path as the propagation medium in the LAN executed in the provided wireless LAN 13 can be prevented as well.

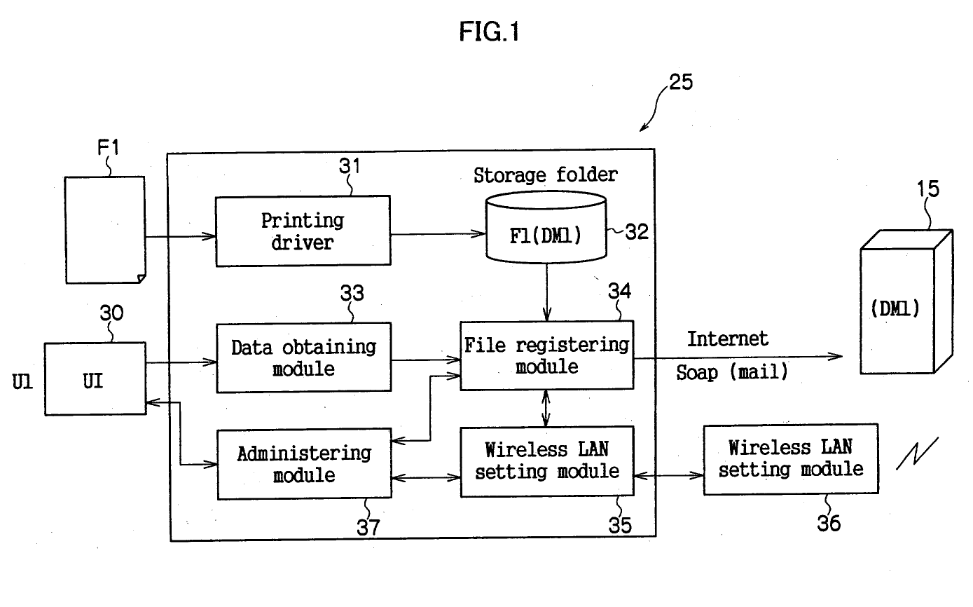

The example of the principal part configuration of the laptop personal computer 25 to be carried and operated by the user U1 is as shown in FIG. 1.

(A-1-1) Internal Configuration Example of the Laptop Personal Computer

In FIG. 1, the laptop personal computer 25 comprises a user interface (UI) 30, a printing driver 31, a storage folder 32, a data obtaining module 33, a file registering module 34, a wireless LAN connecting module 35, a wireless LAN setting module 36, and an administering module 37.

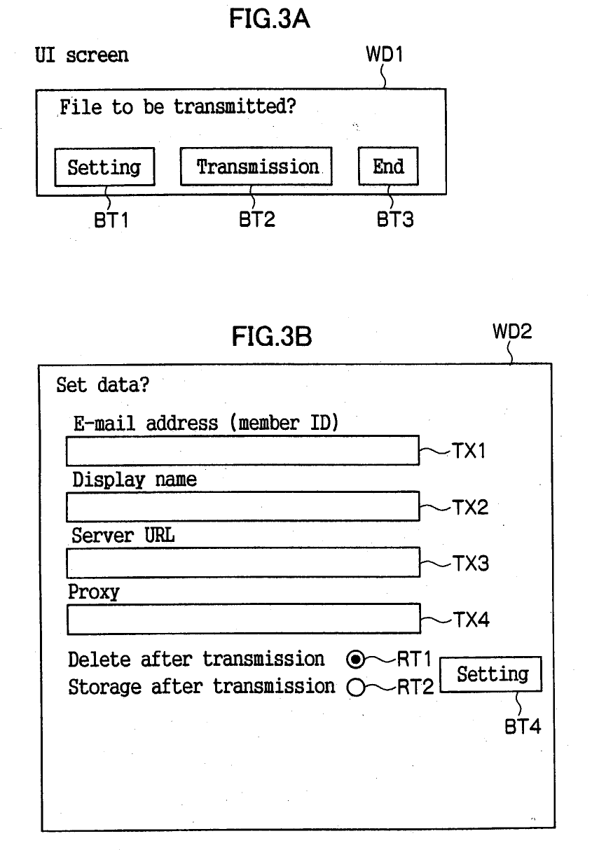

Among these elements, the user interface 30 includes not only a display unit (such as a liquid crystal display unit, or the like) for display screens such as the windows WD1, WD2 as shown in FIGS. 3A, 3B, but also key boards, a pointing device, or the like for transmitting the command of the user U1 to the laptop personal computer. The setting information (user setting information) input by the user U1 via the windows WD1, WD2, or the like is stored in an unshown hard disc, or the like in the laptop personal computer 25 as the user setting file by the file system.

The data obtaining module 33 is a section for obtaining the corresponding user setting information from the user setting file as needed so as to hand down the same to the file registering module 34.

The printing driver 31 has a function for converting a supplied printing subject file F1 of an optional data format to a file F1 (DM1) of the data format DM1 to have registration by the virtual printing server 15 and processed thereby. The printing driver 31 needs to be installed preliminarily, but in this embodiment, as in the case of utilizing printer units of various types, installed at the business convenience stores, there is no need of installing a new driver each time a printing operation is executed by a different printer unit so that a printing output can be executed using a large number of the printing terminals 16 distributed and installed in a wide area as long as the printing driver 31 corresponding to the data format DM1 is installed.

The types of the large number of the printing terminals 16 are not single, but if only the printing subject file F1 (DM1) of the dataformat DM1 is registered, the virtual printing server 15 can convert the data format DM1 of the printing subject file F1 (DM1) to the data format compatible to the printing terminal 16 to execute the printing output.

The supply source of the printing subject file F1 to be the origin of the printing subject file F1 (DM1) can vary. For example, in the case the printing subject file F1 is a file stored in a recording medium such as a CD-ROM, the recording medium is the supply source, and in the case it is an HTML file or an image file comprising a Web page viewed by the user U1, the cache area provided on the hard disc of the laptop personal computer 25 is the supply source.

In general, since a communication terminal mounting a Web browser such as a laptop personal computer has a cache area for storing a file as a constituent element of a Web page viewed so far, a file in the cache area can be designated so as to be a printing subject file F1. A Web page often includes one or a plurality of image files in addition to a basic HTML file. It is better to use these files as the printing subject file F1 per a file unit.

The storage folder 32 is a logical constituent element for storing the printing subject file with the data format converted to DM1 by the printing driver 31. The physical substance for supporting the storage may be the same hard disc as that ensuring the above-mentioned cache area. In the storage folder 32, a plurality of printing subject files can be stored at the same time, however, for simplifying the explanation, the number of the printing subject files to be stored at the same time is set as one here.

The file registering module 34 is a section for transmitting the printing subject file F1 (DM1) read out from the storage folder 32 according to the user setting information handed down from the data obtaining module 33 to the virtual printing server 15 or the in-house printing spooler 21. In the case of using an electronic mail therefor, a process corresponding to the SMTP protocol is executed, and in the case the XML file is used, a process corresponding to the SOAP (HTTP) protocol is executed as the function of the file registering module 34. Therefore, the function of the file registering module 34 corresponds to the hierarchy of the transport layer of the OSI reference model or higher.

After completing the transmission, the printing subject file may remain in the storage folder 32, however, in this embodiment, from the viewpoint of saving the memory capacity of the hard disc, or the like, the printing subject file after completing the registration request is deleted automatically by the file registering module 34 unless otherwise commanded by the user U1.

At the time of requesting registration of a file, the wireless LAN connecting module 35 and the wireless LAN setting module 36 execute the process of the hierarchy of the network layer of the OSI reference model or lower.

Among them, the wireless LAN connecting module 35 executes the process corresponding to the network layer of the OSI reference model, and the wireless LAN setting module 36 executes a process corresponding to the hierarchy of the data link layer or lower.

Therefore, the function of the above-mentioned DHCP client, or the like for receiving allocation of the private IP addresser the like can correspond to the wireless LAN connecting module 35.

Moreover, the wireless LAN setting module 36 is a section corresponding to the above-mentioned wireless LAN adopter in terms of the hardware (corresponding to the driver thereof in terms of the software), for a process concerning the MAC address corresponding to the data link layer, or transmitting or receiving the electric wave in the 2.4 GHz band corresponding to the physical layer. Since all the wireless LAN adopters are allocated with a unique MAC address in the production step, when a wireless LAN adopter transmits a MAC frame by wireless, its own MAC address is described in the frame header as the addresser MAC address. On the communication device (such as the access point 24) side which receives the MAC frame, the addresser wireless LAN adopter can be specified uniquely by confirming the addresser MAC address. Therefore, also in the case of executing the above-mentioned user authentication, the addresser MAC address can be utilized.

Furthermore, since information such as the ESS-ID corresponds to a hierarchy of the data link layer or lower, it can be set in the wireless LAN setting module 36. The ESS-ID forms a group of the access points (such as 24) and the communication terminals (here, the laptop personal computer 25), and prevents interference with the access resource providing services provided by the other service providing agents by allowing communication only in the groups (that is, between the communication devices with the same ESS-ID set). The interference prevention measure can be regarded also as a kind of the security measure.

In order to certainly execute the interference prevention, the set ESS-ID needs to be unique. Also in order to ensure the uniqueness of the ESS-ID, the above-mentioned MAC address (such as the MAC address of the access point 24) can be utilized because the uniqueness of the MAC address is ensured strictly under the detailed standards.

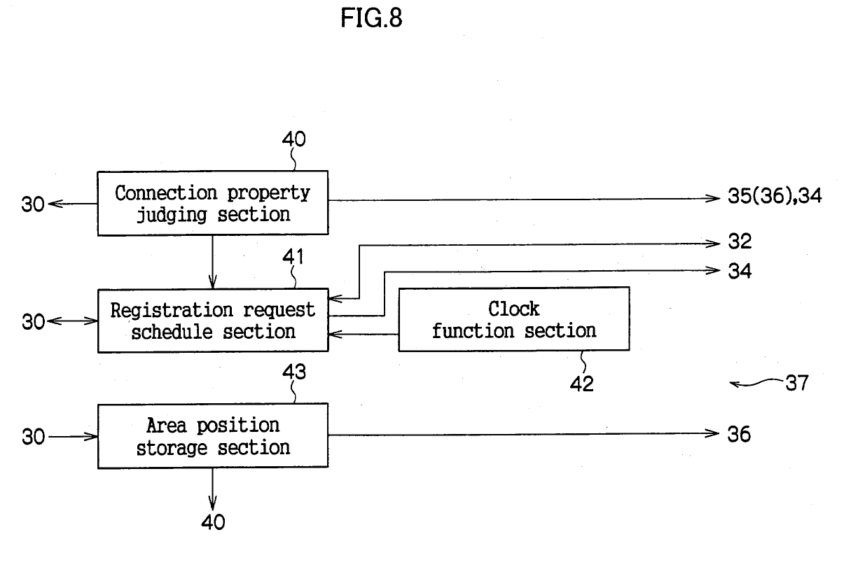

Next, an internal configuration example of the administering module 37 will be explained with reference to FIG. 8. Although many functions are provided in the administering module 37 in FIG. 8, as needed, obviously the functions can be divided into other modules.

(A-1-2) Internal Configuration Example of the Administering Module 37

In FIG. 8, the administering module 37 comprises a connection property judging section 40, a registration request schedule section 41, a clock function section 42, and an area position storage section 43.

Among these elements, the connection property judging section 40 is a section for judging whether or not it is connected with the above-mentioned access point. The judgment result is supplied to the user interface 30 or the registration request schedule section 41. Since the physical level connection property (whether or not an electric wave can be reached normally, or the like) corresponds to the physical layer of the OSI reference model, it can be judged based on the information supplied from the wireless LAN setting module 36. However, since the logical level, in particular the IP level connection property (whether or not the private IP address allocation can be received normally from the above-mentioned DHCP server, or the like) corresponds to the network layer of the OSI reference model, it is judged based on the information supplied from the wireless LAN connecting module 35.

Moreover, since the establishment of the TCP connection to be described later corresponds to the transport layer, it is judged based on the information supplied from the file registering module 34.

By utilizing the above-mentioned ESS-ID, whether or not it is connected with the access resource providing service of a specific service providing agent (such as the ESI) can be judged by the connection property judging section 40.

The registration request schedule section 41 administers the schedule (a part of the above-mentioned user setting information) concerning transmission (the transmission is substantially equal to the registration request to the virtual printing server 15) of the printing subject file (here, F1 (DM1)) preliminarily set by the user U1 via the user interface 30 for supporting realization of the schedule as needed. For the administration or support, the registration request schedule section 41 interchanges the information with the storage folder 32, the file registering module 34, the connection property judging section 40, and the clock function section 42.

That is, the registration request schedule section 41 receives the time information T1 showing the present time from the clock function section 42 for recognizing the present time. The registration request schedule section 41 can always refer to the content of the storage folder 32 for confirming whether or not the printing subject file remains in the storage folder 32, and can receive the judgment result of the connection property judging section 40 for confirming the connection property. In the case the connection property is ensured, the registration request schedule section 41 can provide the file transmission command for executing automatic transmission of the printing subject file (registration request) to the file registering module 34 according to the above-mentioned registration request schedule.

In the case the registration request schedule set by the user U1 has the content of for example “completing the registration request of the printing subject file F1 (DM1) utilizing the access resource providing service of the service providing agent ES1 by 6:15PM of May 25, 2002” (SC1), if an untransmitted printing subject file F1 (DM1) remains in the storage folder 32 and the connection property with respect to the access resource providing service of the service providing agent ES1 is not ensured even though the registration request schedule time (for example, at 6:00PM of May 25, 2002) is close, the registration request schedule section 41 displays a message from the user interface 31 of for example “in order to execute the file registration request according to the schedule, it is necessary to move to the cover area of the access resource providing service of the service providing agent ES1 by 6:15PM of May 25”, or the like for promoting the cooperation of the user U1.

The area position storage section 43 is a section for receiving and storing the area position information for specifying the access resource providing service of the service providing agent (here, ES1) from the user interface 30. The area position information is supplied as needed to the connection property judging section 40 or the wireless LAN setting module 36. The area position information may be information corresponding to the above-mentioned ESS-ID.

Moreover, as mentioned above, in consideration of the difficulty of setting the cover areas of a plurality of service providing agents at the same point in reality, information of specifying the geographical position of the cover area (for example, the “lobby of the OO hotel” or in front of the “xx ticket gate of Shinjuku station”, or the like) can be used as the area position information. By utilizing the function of the connection property judging section 40, or the like by the user ul manually at the time of moving to the position, the printing subject file can be transmitted wirelessly so as to execute the registration request.

Need of designation of the service providing agent of the access resource providing service utilized for the printing subject file registration request rises because the widths of the access line band differ depending on the service providing agents, and direct contract of the user U1 with the ISP is in some cases needed and in the other cases not needed.

In the case the printing subject file F1 (DM1) for the registration request execution is a large capacity image file, or the like, it is advantageous in terms of the mobility to select a service providing agent with a wide access line so as to save the communication time (during the communication time, obviously it is necessary to stay in the cover area). In the case the user U1 does not have a contract with any of the ISP, it is necessary to select a service providing agent usable without the contract with the ISP. Moreover, in the case of a chargeable access resource providing service, only the service providing agent with the preliminary member registration of the user U1 can be used.

Of course, designation of the service providing agent in the above-mentioned registration request schedule can be omitted in many cases such as the case not corresponding to these cases, or the like.

The service providing agent ES1 of the access resource providing service can obviously be identical to the agent PS1 running the virtual printing server PS1.

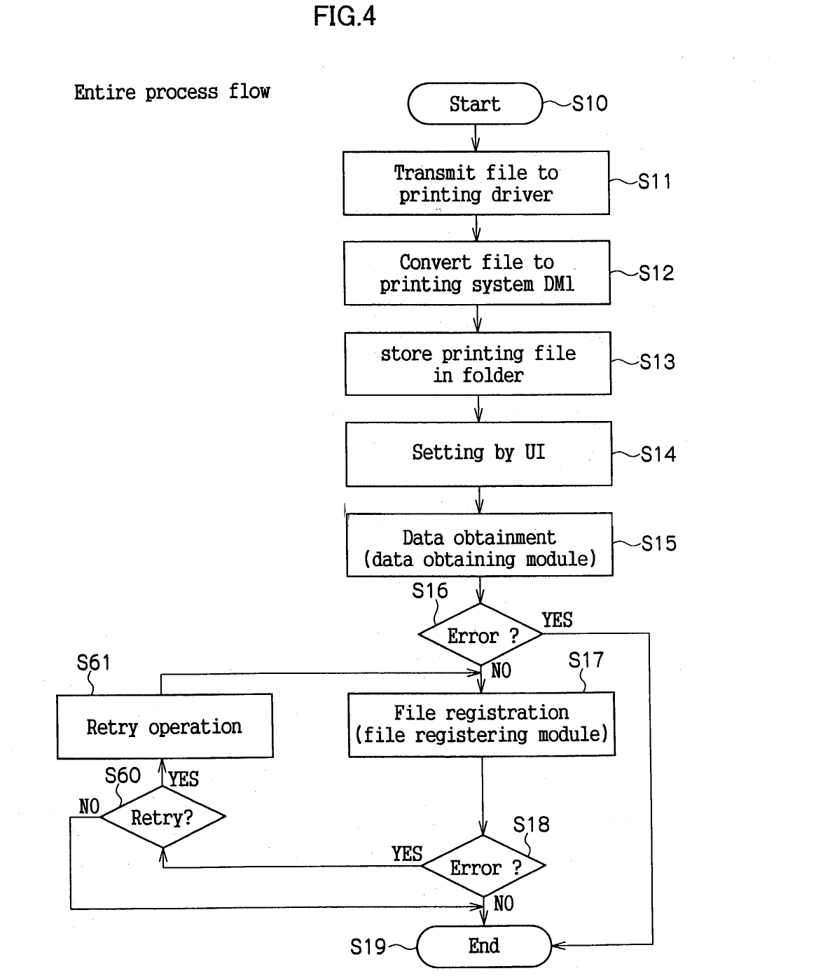

Hereinafter, the operation of this embodiment having the above-mentioned configuration will be explained with reference to the flow charts shown in FIGS. 4 to 6.

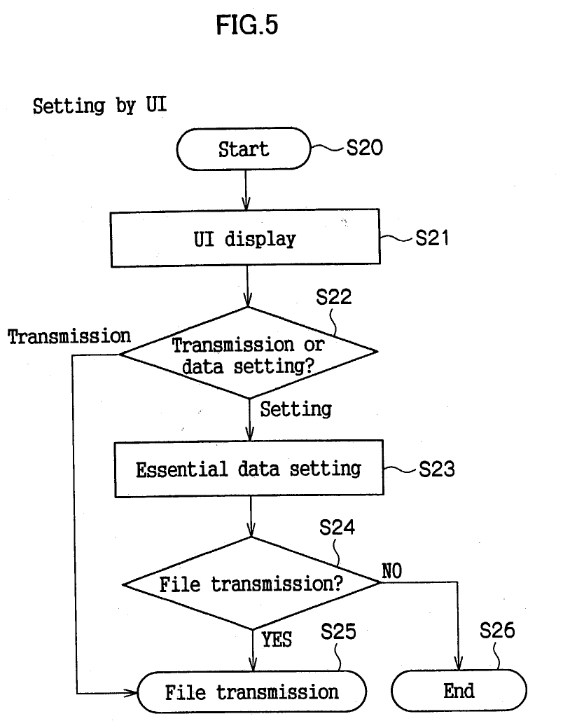

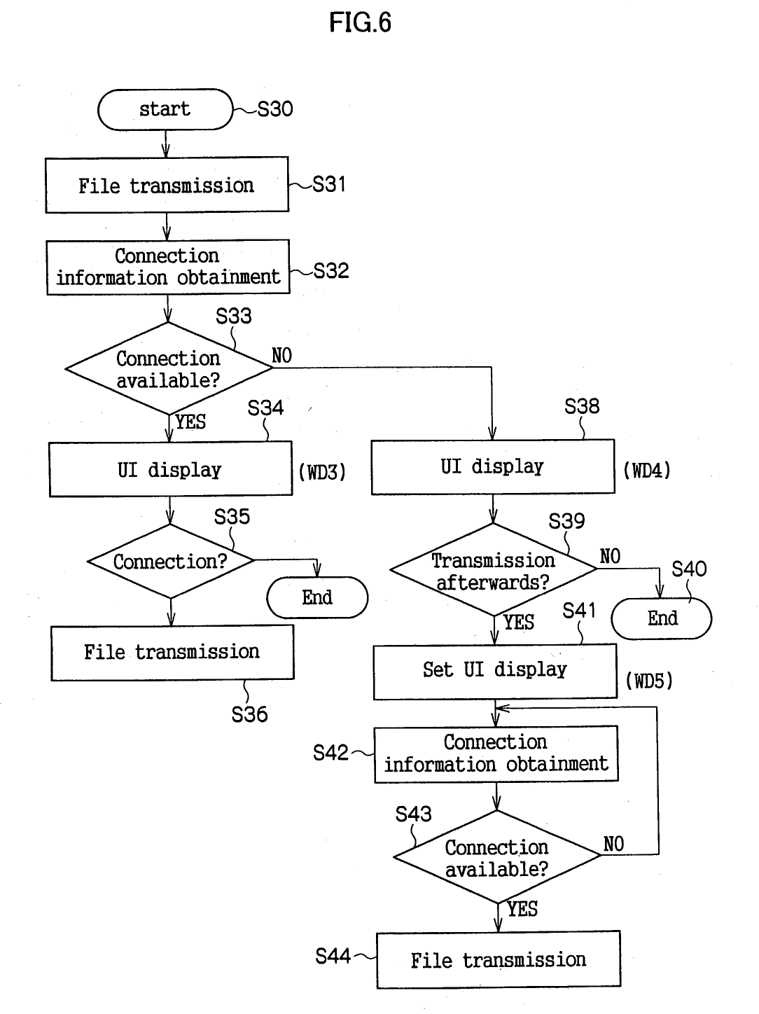

The flow chart shown in FIG. 4 includes the steps from S10 to S19, S60 and S61. The flow chart shown in FIG. 5 includes the steps from S20 to S26. The flow chart shown in FIG. 6 includes the steps from S30 to S44.

FIG. 4 is a flow chart showing the entire schematic process flow in the laptop personal computer 25, and FIG. 5 is a flow chart of the case of setting the user setting information using the user interface 30. In relation to FIG. 4, FIG. 5 shows the details of the step S14 of FIG. 4.

Moreover, FIG. 6 is a flow chart showing the process flow at the time of wireless transmission of the printing subject file from the laptop personal computer 25. In relation to FIG. 4, FIG. 6 shows the details of the step S17 of FIG. 4.

(A-2) Operation of the First Embodiment

In the case the user U1 carrying the laptop personal computer 25 designates a file comprising a Web page viewed by him/her or a file stored in a recording medium as a printing subject file F1 and transmits the same to the printing driver 31 using the user interface 30 at the outside (S10, S11), the printing driver 31 immediately converts the data format of the printing subject file F1 to DM1 (S12) and stores the printing subject file F1 (DM1) in the storage folder 32 (S13).

Thereafter, according to the registration request of the printing subject file F1 (DM1) to the virtual printing server 15, the user U1 sets the above-mentioned user setting information, using the user interface 30 (S14).

According to this setting, in the steps S20 and S21 of FIG. 5, first, for expel the window WD1 shown in FIG. 3A is displayed on the screen. In the case the user U1 operates the “setting” button BT1 on the window WD1, the step S22 is stemmed to the setting side so that the window WD2 shown in FIG. 3B is displayed on the screen. Thereafter, specific setting is carried out by utilizing the text boxes TX1 to TX4 and the radio buttons RT1 and RT2 on the window WD2.

The text boxes TX1 to TX4 (and the radio buttons RT1 and RT2) may be blank in the initial state at the time of the screen display in the step S21. However, by describing the content of the time of the use (or the preliminarily designated content) in the initial state so that only the content of a text box (or a radio button) to be changed is changed by the user, the operation load of the user U1 can be made smaller, and thus it can be convenient. In general, editing functions necessary for edition of a document are effective on the text box.

Among the text boxes TX1 to TX4, TX1 is the area for describing the electronic mail address. The electronic mail address is the information used as the member ID at the time of the member registration of the user U1 to the virtual printing server 15. Therefore, the electronic mail address of the user U1 himself is described on the text box TX1.

The text box T2 is the area for describing the file name of the printing subject file F1 (DM1). The file name of the printing subject file F1 (DM1) may be automatically generated based on the file name of the original file F1. Moreover, as needed, a name of the display as the substitute of the file name can be described by the user U1.

The text box TX3 is the area for describing the URL of the virtual printing server 15. The text box TX4 is the area for describing the information such as the IP address, the port number, or the like of the proxy server on the firewall wherein the VPN section 22 exists. The information on the text boxes TX3 and TX4 is utilized for executing the above-mentioned SOAP protocol. The information on TX3 is necessary at the time of requesting registration by transmitting the printing subject file F1 (DM1) to the virtual printing server 15. The information on TX4 is necessary at the time of transmitting the printing subject file F1 (DM1) to the in-house printing spooler 21.

The radio buttons RT1 and RT2 are buttons for setting the information necessary for the process to be executed in the laptop personal computer 25 after transmitting the printing subject file F1 (DM1).

That is, as shown in the drawing, in the case RT1 is filled, the printing subject file (for example, F1 (DM1)) in the storage folder 32 is automatically deleted after the transmission, but in the case RT2 is filled, it is continued to be stored without deletion.

In the case the description content of the text boxes TX1 to TX4 on the window WD2 is established, the user U1 operates the “setting” button BT4 so that the description content on TX1 to TX4 is stored in the above-mentioned user setting file (S23).

The “transmission” button BT2 on the window WD1 shown in FIG. 3A is a button to be operated at the time of commanding the transmission of the printing subject file F1 (DM1) by the user U1 manually. With the premise that the user setting information to be described on the text boxes TX1 to TX4 of the window WD2 is already obtained, the manual file transmission is executed (S24, S25).

In the case the registration request of the printing subject file F1 (DM1) is executed automatically according to the above-mentioned registration request schedule, utilizing the above-mentioned ESS-ID, or the like, the printing subject file F1 (DM1) is transmitted automatically without using the window WD1.

Moreover, the “end” button BT3 is a button to be operated at the time the setting of the user setting information or the transmission of the printing subject file F1 (DM1) is completed, or it is canceled without execution. In the case the “end” button BT3 is operated, the step S24 is stemmed to the NO side so as to finish the process (S26). It is also possible that the process is finished by operating the “end” button BT3 in the step S22.

In the case the file transmission of the printing subject file F1 (DM1) is executed either manually or automatically, the file registering module 34 is operated.

Since the file registering module 34 obtains the information such as the addressee of the printing subject file F1 (DM1) by receiving the user setting information from the data obtaining module 33 (step S15 of FIG. 4), in the case the user setting information is apparently mistaken or incomplete, the step S16 of FIG. 4 is stemmed to the YES side so as to finish the process without transmission of the printing subject file F1 (DM1) (S19).

However, as needed, it is also possible that the process is returned to the step S14 in the case the step S16 is stemmed to the YES side so that input (correction or re-input) of the user setting information is requested by displaying the above-mentioned window WD2 on the screen.

In the case appropriate user setting information is obtained and transmission of the printing subject file F1 (DM1) is commanded manually or automatically, the file registering module 34 executes the file transmission so that the wireless LAN connecting module 35 and the wireless LAN setting module 36 on the lower hierarchy support the execution.

Since the SOAP using the HTTP as the communication protocol has a connection type TCP as the transport layer protocol, a highly reliable transmission can be executed on the transport layer level. Therefore, in the case the TCP connection is provided, the printing subject file F1 (DM1) can certainly be transmitted to the in-house printing spooler 21 or virtual printing server 15, but for example, if the laptop personal computer 25 is outside the cover area of the access resource providing service, an electric wave cannot be reached physically so that the wireless propagation path does not exist, thus the TCP connection cannot be provided so that the step S18 is stemmed to the YES side.

Moreover, even in the case the laptop personal computer 25 is disposed in the cover area of the access resource providing service so that the electric wave can be reached physically, if a trouble is present in the addressee in-house printing spooler 21 or the virtual printing server 15, or the like, the TCP connection cannot be established so that the step S18 is stemmed to the YES side.

In terms of the incapability of normal transmission of the printing subject file F1 (DM1), the case unable to establish the TCP connection and the case unable to reach the electric wave are same. However, since the measure to be taken by the user U1 to deal with the situation differs, it is desirable that whether it is stemmed to the YES side due to incapability of establishing the TCP connection or it is stemmed to the YES side due to incapability of reaching the electric wave is displayed so that the user U1 can distinguish thereof in the case the step S18 is stemmed to the YES side.

In the case the TCP connection cannot be established, change of the method for transmitting the printing subject file F1 (DM1) to the SOAP or the electronic mail can be the measure to be taken by the user U1 (this may be changed automatically by the laptop personal computer 25). In the case the electric wave cannot be reached, movement from the present position is the substantially only one measure to be taken by the user U1.

Even in the case for example the communication by the SOAP cannot be executed normally, if the mail server (not only 20 but also an unshown mail server to be provided in the virtual printing server 15) can be used normally, the printing subject file F1 (DM1) can be transmitted, using an electronic mail.

The display for allowing the user U1 to distinguish whether it is stemmed to the YES side due to incapability of establishing the TCP connection or it is stemmed to the YES side due to incapability of reaching the electric wave can be provided, utilizing the judgment result by the connection property judging section 40 in the administering module 37.

This is because the connection property judging section 40 obtains information from the wireless LAN connecting module 35, the wireless LAN setting module 36 and the file registering module in the step S32 shown in FIG. 6, and judges whether or not the connection can be achieved in the step S33.

In consideration of these points, in the case the step S18 in FIG. 4 is stemmed to the YES side, whether or not the connection is to be re-executed (retry) is inquired to the user U1 via the user interface 30 in the subsequent step S60. In the case the user U1 does not show the intention of the re-execution, the step S60 is stemmed to the NO side so as to finish the process (S19). In the case the user shows the intention of the re-execution, the step S60 is stemmed to the YES side so that the process proceeds to the step S61 so as to execute a predetermined retry operation.

The specific content of the retry operation may be various ones. As an example, one automatically repeating the step S17 process by a predetermined time (for example, about 5 times) with a certain time interval (for example, about 5 seconds) may be used. Moreover, the retry operation may include a process for changing over the communication by the SOAP to the communication by the electronic mail (automatically, or according to a command from the user U1). The retry operation corresponds to the above-mentioned measure to be taken by the user U1 in the case the printing subject file F1 (DM1) cannot be transmitted normally.

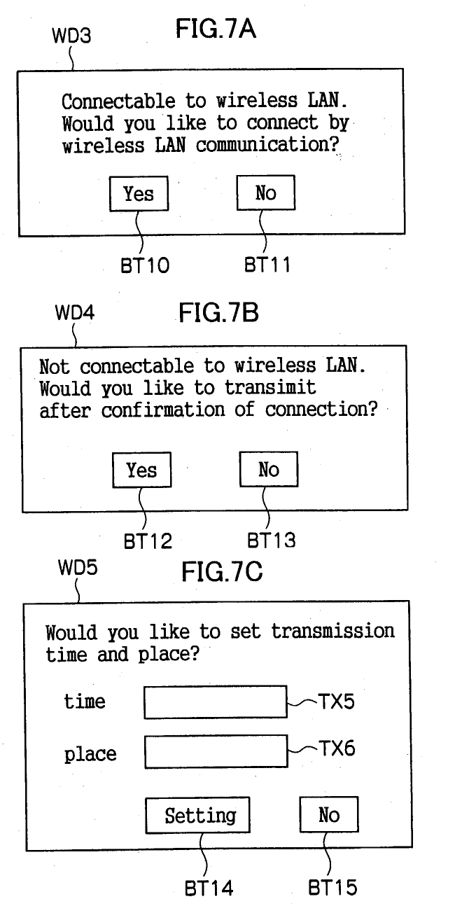

In the case the connection is possible and the step S33 in FIG. 6 is stemmed to the YES side, for example, the window WD3 shown in FIG. 7A is displayed on the screen of the user interface 30 (S34). In the case the “yes” button BT10 is operated on the window WD3, the file registering module 24, the wireless LAN connecting module 35, and the wireless LAN setting module 36 are connected with the access point 24 in the provided wireless LAN 13 so as to execute the file transmission (S35, S36).

In the case the “no” button BT11 is operated on the window WD3, the process is finished without executing the connection (S37).

In contrast, in the case the connection is impossible and the step S33 is stemmed to the NO side, for example, the window WD4 shown in FIG. 7B is displayed on the screen of the user interface 30 (S38). In the case the user U1 operates the “no” button BT13 on the window WD4, the process is finished (S40), however, in the case the user U1 operates the “yes” button BT12 so as to show the intention of executing the transmission at the time the connection with the wireless LAN is confirmed (the connection concept may include the TCP connection establishment) even though the transmission cannot be executed at the moment, for example, the window WD5 shown in FIG. 7C is displayed on the screen (S41).

The window WD5 comprises text boxes TX5 and TX6 so as to describe the above-mentioned registration request schedule content.

In the case the content of the registration request schedule is for example “completing the registration request of the printing subject file F1 (DM1) utilizing the access resource providing service of the service providing agent ES1 by 6:15PM of May 25, 2002” (SC1) as mentioned above, “6:15PM of May 25, 2002” is described in the text box TX5 corresponding to the time, and for example, the “lobby of the OO hotel”, is described in the text box TX6 corresponding to the place (the cover area of the access resource providing service of the service providing agent ES1 is set at the lobby).

Here, since only one printing subject file F1 (DM1) is stored in the storage folder 32, the printing subject file needs not be specified on the window WD5. However, in the case a plurality of printing subject files can be stored in the storage folder 32, the printing subject file to be transmitted needs to be specified by describing the file name by the user U1, displaying the list of the file names for selection by the user U1, or the like.

Transmission of the printing subject file F1 (DM1) may be stored in the log file (not shown) in the laptop personal computer 25 as needed.

Even in the case of non-connection according to the intention of the user U1 with the step S35 stemmed to the NO side, the steps S38 and S39 may be executed without finishing the process as mentioned above.

Moreover, in the case the content the registration request schedule includes a new condition added to the above-mentioned SC1, for example, “completing the registration request of the printing subject file F1 (DM1) utilizing the access resource providing service of the service providing agent ES1 between 5:00PM to 6:15PM of May 25, 2002” (SC2), or the like, too early the file registration request may be problematic, and in order to deal with such a case, it is preferable to display the window for describing the registration request schedule on the screen regardless of whether or not the connection to the access point 24 can be achieved.

The step S42 subsequent to the step S41 is a process corresponding to the step S32, and the step S43 is a process corresponding to the step S33. However, in the case the step S43 is stemmed to the NO side, the process is returned to the step S42.

In the case the step S43 is stemmed to the YES side, the file transmission is executed as in the step S36 (S44).

In the case the printing subject file F1 (DM1) is transmitted to the in-house printing spooler 21 by the file transmission, the file registration is executed according to the transmission of the printing subject file F1 (DM1) from the in-house printing spooler 21 to the virtual printing server 15. In the case it is transmitted from the laptop personal computer 25 to the virtual printing server 15 without passing through the in-house printing spooler 21, the file registration is executed according to the transmission thereof.

However, at the time of registering the file, since the user authentication is executed, utilizing the electronic mail address (member ID), or the like described in the text box TX1 of FIG. 3B, in the case the authentication result is NG, the virtual printing server 15 rejects the registration of the printing subject file F1 (DM1), and the registration is executed only when the authentication result is OK.

According to the registration, the printing subject file F1 (DM1) is stored temporarily in the virtual printing server 15. Then, in the case the printing output request from the user U1 is received via the internet 11, the virtual printing server 15 transmits the printing subject file F1 (DM1) to the printing terminal 16 designated by the printing output request for executing the printing output.

The advantages of registering the printing subject file F1 (DM1) in the virtual printing server 15 by the path via the in-house printing spooler 21 include that the communication by the user U1 as an employee can be administered by the company side, and the mobility can be ensured by shortening the communication time of the laptop personal computer 25 in the case the band range of the access line 15A between the virtual printing server 15 and the internet 11 is narrower than the band range of the intranet 12A and the communication speed is low.

In the case it passes through the in-house printing spooler 21, the time for executing the registration request to the virtual printing server 15 (registration request schedule time) can be administered on the intranet 12 side. For example, in the case of the schedule content as the above-mentioned SC2, the possibility of executing the registration request loyal to the preset registration request schedule time (for example, between 5:00PM to 6:15PM of May 25, 2002) is high by administering the same on the intranet 12 side with the connection property with respect to the internet 11 ensured without moving rather than by administering the same on the moving laptop personal computer 25 side.

Furthermore, it is also advantageous in that the storage folder 32 on the laptop personal computer 25 side can be made empty once the printing subject file is transmitted to the in-house printing spooler 21 so that the limited memory capacity can be utilized effectively for storing a new printing subject file.

Also at the time of transmitting the printing subject file F1 (DM1) from the in-house printing spooler 21 to the virtual printing server 15, enciphered can be applied as needed.

The enciphered may be executed according to the function of the in-house printing spooler 21 itself, and it may be executed also by utilizing the function of the VPN section 22.

By linking the VPN section 22 and the packet filter of the fire wall, or the like, whether or not the enciphered is to be applied can be selected each time according to the addressee on the internet 11 (moreover, according to the communication application (port number)).

(A-3) The Effect of the First Embodiment

As heretofore mentioned, according to this embodiment, by using the laptop personal computer with a printing driver (31) corresponding to the data format (DM1) of the virtual printing server installed, since the printing output of the printing subject file (F1 (DM1)) can be executed via an optional printing terminal selected among a large number of the printing terminals (16) distributed and installed in a wide area, the load on the user (U1) is light so that the excellent usability and convenience can be provided.

(B) Second Embodiment

Hereinafter, only the points of this embodiment different from those of the first embodiment will be explained.

In this embodiment, according to the above-mentioned process of having the user U1 select a desirable printing terminal by showing several printing terminals 16 close to the present position of the laptop personal computer 25 at the time of transmitting the printing subject file by the laptop personal computer 25, some points not clearly described in the first embodiment will be specified.

This function is particularly effective in the case the user wants to receive the printing output immediately after the printing subject file transmission. In consideration of the actual average users, such a case is considered to be most frequent.

(B-1) Configuration and Operation of a Second Embodiment

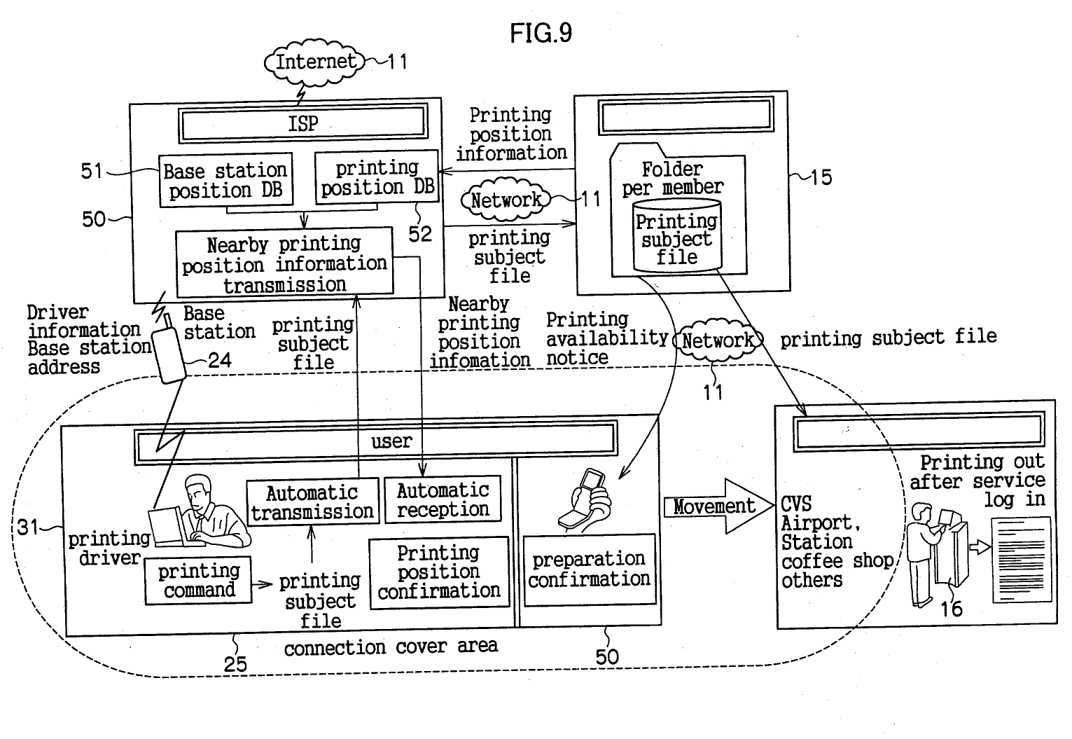

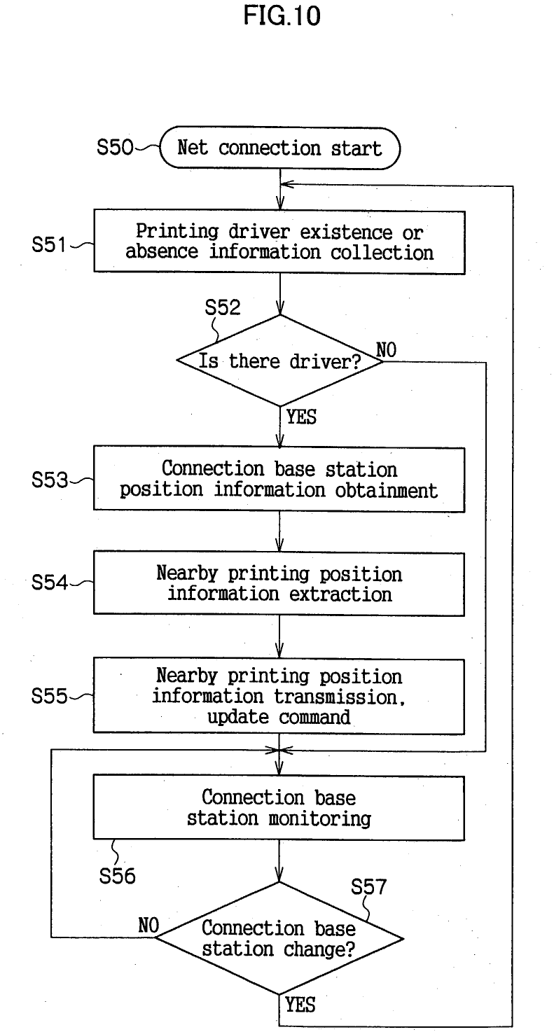

A configuration example of the principal part of this embodiment is shown in FIG. 9, and an operation example is shown in the flow chart of FIG. 10.

In FIG. 9, since the function of the constituent elements provided with the same numerals 11, 15, 16, 24, 25, 31 as in FIGS. 1 and 2 is same as that in the first embodiment, detailed explanation thereof is not given.

A printing position guiding server 50 shown in FIG. 9 is a server having a function of showing several nearby printing terminals 16 to the user U1 who has transmitted the printing subject file F1 (DM1) (registration request). The printing position guiding server 50 has a base station position data base 51, and a printing position data base 52. The printing position guiding server 50 is provided in the ISP network for storing the access line 14A (or 13A).

As explained in the first embodiment, so far, most of the access resource providing services comprise only one access point (for example, the above-mentioned 24), however, since a large number of access resource providing services are stored in one ISP network, a large number of access points (one of which is the above-mentioned 24) exist under one ISP network.

Then, in consideration of the fact that it is difficult to set cover areas at the same points by a plurality of service providing agents, and the fact that the size of the cover area is at most a 50 m radius (or 200 m), these access points in most cases are disposed with at least about 50 m (or 200 m) interval.

In the local station position data base 51, the information showing the geographical positions (base station position information) of these access points (that is, the wireless base stations) are accumulated in a form corresponding to the identifiers (for example, the IP address) of the access points.

Moreover, in the printing position data base 52, the information showing the geographical positions (printing position information) of a large number of the printing terminals 16 distributed and installed in a wide area is accumulated in a form corresponding to the identifiers (for example, the MMK-ID) of the printing terminals 16.

In the flow chart of FIG. 10 comprising the steps S50 to S57, in the case the user U1 carrying the laptop personal computer 25 is in the cover area of the provided wireless LAN 13, when the connection is executed from the laptop personal computer 25 to the ISP network via the access point 24 (S50), the printing position guiding server 50 in the ISP network confirms whether or not the laptop personal computer 25 comprises the printing driver 31 (S51, S52).

Since it can be the subject of the process of the printing position guiding server 50 only in the case the printing driver 31 is provided, if the printing driver 31 is not provided and the step S52 is stemmed to the NO side, an operation of consecutively selecting and monitoring the access point 24 of the provided wireless LAN 13 and the access point of the provided wireless LAN of the other service providing agents is repeated until the connection from the laptop personal computer (for example, 25) with the printing driver mounted 31 is found (S56, S57).

Those that access to the internet 11 utilizing the access resource providing service are not limited to the laptop personal computer 25 with the printing driver 31 mounted.

In the case one connected with the ISP network is the laptop personal computer 25, since the printing driver 31 is already mounted, the step S52 is stemmed to the YES side.

As to the method of recognizing whether or not the printing driver 31 is mounted in the laptop personal computer 25 by the printing position guiding server 50, or the communication procedure, various ones are conceivable. As an example, whether or not the printing driver 31 is provided may be recognized by providing predetermined identification information at a predetermined position on the payload of the IP packet (or the peayload of the TCP packet) at the time the printing subject file F1 (DM1) is transmitted from the laptop personal computer 25, and detecting whether or not the identification information exists.

Or in the case the data format DM1 is a data format specific to the virtual printing server 15 not used in the other system, it is also possible to recognize whether or not the printing driver 31 is mounted by detecting the data format.

In the case the printing subject file F1 (DM1) is transmitted from the laptop personal computer 25, the content of the printing subject file F1 (DM1) is stored in the IP packet and transmitted so that the IP packet reaches to the ISP network from the access pint 24 in the provided wireless LAN 13 through the access line 13A (14A) so as to be received by the printing position guiding server 50 in the ISP network.

The printing position guiding server 50 receiving the IP packet has the IP packet rooted according to the addressee IP address (the addressee is the in-house printing spooler 21 (mail server 20) or the virtual printing server 15), and whether or not the printing driver 31 is mounted is examined by itself using the above-mentioned method.

Then, in the case the printing driver 31 is recognized to be mounted as a result of the examination, the printing position guiding server 50 refers to the addresser IP address of the IP header for the IP packet. Next, in the case the base station position data base 51 is retrieved with the addresser IP address provided as the retrieval key, the above-mentioned base station position information can be obtained as the retrieval result (S53).

Since the IP header is outside the subject of the enciphered in the IP sec enciphered using the ESP header executed corresponding to the above-mentioned VPN, it is possible that the printing position guiding server 50 refers to the addresser IP address stored in the IP header.

Furthermore, the printing position guiding server 50 retrieves the printing position data base 52 using the base station position information. In the case for example, the position information of the longitude and the latitude is stored as the base station position information and the printing position information, the MMK-ID of the total printing terminals 16 with the geographical distance of less than a predetermined value can be obtained by the retrieval (S54).

By storing the installation position description in a natural language easily comprehendible by man is stored in the data bases 51 and 52 in addition to the description by the longitude and the latitude convenient for the information process by the machine as the base station position information and the printing position information, the installation position description can also be obtained according to the retrieval in the steps S53 and S54.

The obtained installation position description list is sent back to the above-mentioned addresser IP address by the printing position guiding server 50 (S55). Subsequent to the step S55, the step S56 is executed.

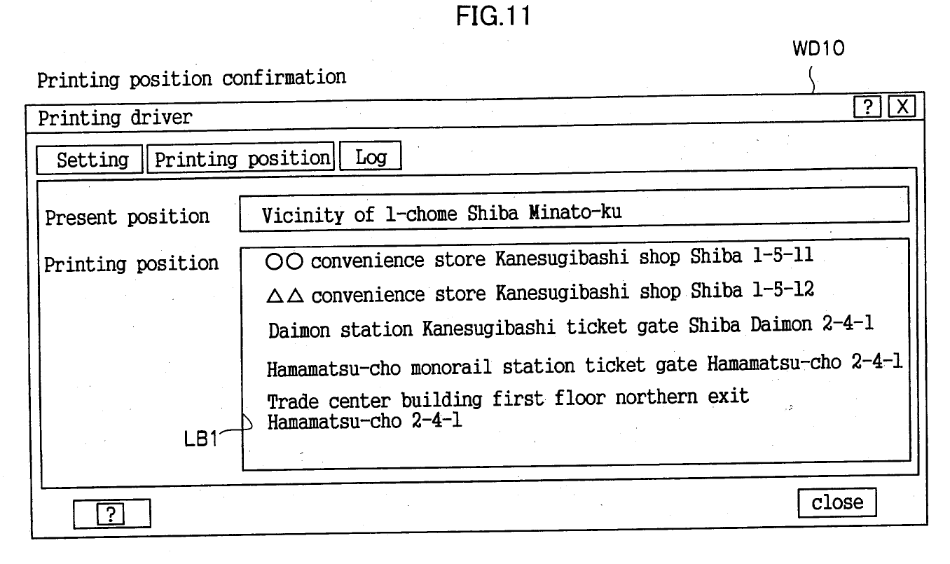

In the laptop personal computer 25 receiving the installation position description list sent back in the step S55 via the access point 24, for example the window WD10 having a list box LB1 as shown in FIG. 11 is displayed on the screen in the user interface 30 thereof.

In the list box LB1, a list of the 5 installation position descriptions with a printing terminal installed close to the present position of the user U1 (that is, in the cover area of the provided wireless LAN 13 (in the example shown in the drawing, the “vicinity of 1-chome Shiba Minato-ku” is described)) is displayed.

Based on the list, the user U1 can receive the printing output of the printing subject file F1 (DM1) from a desired printing terminal 16.

For example, in the case the user U1, moved to the desired printing terminal 16 according to the installation position description shown in the list, operates the printing terminal 16 and inputs the member ID and the password (the member ID and the password are determined preliminarily at the time of the member registration with respect to the virtual printing server 15), the user authentication is executed by the communication between the printing terminal 16 and the virtual printing server 15. In the case the authentication result is OK, already at the time the printing subject file F1 (DM1) stored in the virtual printing server 15 is conveyed to the printing terminal 16 so as to be printed and output.

At this time, as needed, the data format can be converted further from the DM1 to the data format suited for the printing terminal 16 as in the first embodiment.

In order to receive the list of the installation position description, the user U1 should stay in the cover area of the provided wireless LAN 13. However, by restraining the time between the receipt of the above-mentioned IP packet by the printing position guiding server 50 to send back of the installation position description list in a few seconds, the time necessary for the user U1 to stay in the cover area of the provided wireless LAN 13 for receiving the list can be sufficiently shortened so that a conveniently usable system can be provided.

The display on the window WD10 may be executed based on the function of the printing driver 31.

Moreover, a portable phone 50 shown in FIG. 9 is used for notifying that the virtual printing server 15 finished the storage of the printing subject file F1 (DM1) so as to complete the printing output preparation and be in the state capable of providing the printing output any time by the electronic mail, or the like.

The electronic mail systems of the portable phone 50 vary, and since most of them can notify the reception of the electronic mail immediately to the user U1 by the receipt sound, the vibration, or the like, it is suitable for such notification.

Since the place with the cover area of the provided wireless LAN set is same as the place with the printing terminal 16 set in terms of the quality as a highly public place, they can highly possibly be provided geographically in the same area (that is, the printing terminal 16 is set in the cover area of the provided wireless LAN). In this case, the distance of the movement of the user U1 to a desired printing terminal 16 according to the installation position description shown in the above-mentioned list can be in most cases within several tens of meters.

(B-2) Effects of the Second Embodiment

According to this embodiment, the same effects as those of the first embodiment can be obtained.

Additionally, since the nearby place with the printing terminal installed can be notified to the user (U1) according to this embodiment, it is extremely usable and highly convenient.

(C) Other Embodiments

Despite the first embodiment, the printing spooler 21 may not be always disposed inside the intranet 12. For example, the printing spooler 12 may be disposed inside the ISP network.

Moreover, as means for executing the registration request of the printing subject file, the SOAP and the electronic mail are prepared in the first embodiment, however with only one of them, the effects of the present invention can be obtained, and furthermore, means other than those can be prepared.

Furthermore, although the path of passing through the printing spooler 21 and the path without passing through the printing spooler 21 are prepared as the paths for requesting the file registration in the first embodiment, it is also possible to use either one of the paths.

Although the laptop computer is shown as an example in the first and second embodiments, the present invention can also be adopted in a portable communication terminal comprising the same function other than the laptop personal computer.

Moreover, the present invention can also be adopted in a communication terminal without portability (such as a desktop type personal computer) because it is possible that the communication terminal is not connected with a printer unit, or the user desires to receive the printing output at the outside.

Although the printing position data base 52 is disposed in the ISP network according to the second embodiment, in consideration of the fact that the number of the printing terminals 16 in a wide area distributed environment may be highly possibly enormous and addition of new printing terminals 16 or deletion are executed from second to second so that the data base registration content should be updated each time (even the communication traffic can be enormous), it is not always preferable to dispose the data base in each ISP network. In this regard, it is also effective to administer the printing position data base collectively on the virtual printing server 15 side so that the inquiry of the printing position information can be executed from the ISP network to the virtual printing server 15, or to utilize the mechanism of a distributed data base.

Although the present invention has been achieved mainly as a software in the above-mentioned explanation, the present invention can also be achieved as a hardware.

As heretofore explained, according to the remote printing system and the remote printing service method of the present invention, the load on the user is light and high usability and convenience can be achieved.

What is claimed is:

1. A remote printing system comprising a remote printing server for receiving registration of printing subject data to be printed from a communication terminal operated by a user for printing the printing subject data from a predetermined printing terminal distributed and installed in a wide area,
wherein the communication terminal comprises:
a data format converting section for converting the data format of the printing subject data to the data format handled by the remote printing server; and
a communication section for transmitting the printing subject data after the conversion and requesting the registration, and
the printing terminal comprises
a printing outputting section for executing the printing output according to the data format handled by the remote printing server.

2. The remote printing system according to claim 1,
wherein the communication terminal comprises a printing subject storage section for temporarily storing the printing subject data,
and the data format converting section converts the data format of the printing subject data before or after storage in the printing subject storage section.

3. The remote printing system according to claim 2, wherein the communication terminal comprises:
a connection availability judging section for judging whether or not the communication section can be connected with a wireless local area network by examining a predetermined connecting condition in the case the communication section accesses to the remote printing server via the predetermined wireless local area network; and
a judgment result providing section for providing the judgment result of the connection availability judging section to the user via a predetermined user interface section.

4. The remote printing system according to claim 2, wherein the communication terminal comprises:
a schedule administering section for administering a preset schedule concerning the registration request, and
a comparison result providing section for comparing the schedule and the present time, and providing information according to the comparison result to the user via a predetermined user interface section.

5. The remote printing system according to claim 2, wherein the communication terminal comprises an identification information setting section for presetting wireless local area network identification information for specifying the wireless local area network for passing through at the time of access to the remote printing server in an environment with a plurality of wireless local area networks of the same kind and with different detailed specifications existing distributed geographically, and
the wireless local area network identification information set in the identification information setting section is utilized for providing wireless local area network guiding information as guiding information concerning the wireless local area network to the user, or for automatically requesting the registration.

6. The remote printing system according to claim 1, comprising a printing spooler terminal for executing the registration request by temporarily accumulating the printing subject data with the data format converted to the data format handled by the remote printing server,
wherein the communication section of the communication terminal accumulates the printing subject data in the printing spooler terminal for executing the registration request to the remote printing server not directly but indirectly via the printing spooler terminal.

7. The remote printing system according to claim 6,
wherein the printing spooler terminal enciphers and transmits the accumulated printing subject data to the remote printing server.

8. The remote printing system according to claim 2, wherein the communication terminal comprises a printing command quick response section for storing a file comprising Web in the printing subject storage section in the case a printing command of a Web page viewed is received from the user.

9. The remote printing system according to claim 2,
wherein an intermediate server is provided between the remote printing server and the communication terminal,
the intermediate server comprises:
a base station position administering section for administering base station position information showing the position of a wireless base station in the wireless local area network in the case the communication section of the communication terminal accesses to the remote printing server via a predetermined wireless local area network;
a printing terminal position administering section for administering printing terminal position information showing the position of the printing terminal; and
a printing terminal guiding information reply section for returning to the communication terminal printing terminal guiding information for guiding the user operating the communication terminal to a printing terminal corresponding to the printing terminal position information geographically close to the position shown by the base station position information of the wireless base station receiving the request at the time a registration request is executed from the communication section of the communication terminal, and
the communication terminal comprises a printing terminal guiding information providing section for providing the printing terminal guiding information to the user.

10. A remote printing service method using a remote printing server for receiving registration of printing subject data to be printed from a communication terminal operated by a user for printing the printing subject data from a predetermined printing terminal distributed and installed in a wide area,
wherein the communication terminal converts the data format of the printing subject data to the data format handled by the remote printing server,
the communication section transmits the printing subject data after the conversion for requesting the registration, and
the printing terminal has the printing outputting section execute the printing output according to the data format handled by the remote printing server.

11. The remote printing service method according to claim 10,
wherein the communication terminal has the printing subject storage section temporarily store the printing subject data, and the data format converting section converts the data format of the printing subject data before or after the storage in the printing subject storage section.

12. The remote printing service method according to claim 11,
wherein the communication terminal has the connection availability judging section judge whether or not the communication section can connect with a wireless local area network by examining a predetermined connection condition in the case the communication section accesses to the remote printing server via a predetermined local area network, and
the judgment result providing section provides the judgment result of the connection availability judging section to the user via a predetermined user interface section.

13. The remote printing service method according to claim 11, wherein the communication terminal has a schedule administering section administer a preset schedule concerning the registration request, and
a comparison result providing section compare the schedule and the present time so as to provide the information corresponding to the comparison result to the user via a predetermined user interface section.

14. The remote printing service method according to claim 11, wherein the communication terminal has the identification information setting section preset for wireless local area network identification information for specifying the wireless local area network for passing through at the time of access to the remote printing server in an environment with a plurality of wireless local area networks of the same kind and with different detailed specifications existing distributed geographically, and
the wireless local area network identification information set in the identification information setting section is utilized for providing wireless local area network guiding information as guiding information concerning the wireless local area network to the user, or for automatically requesting the registration.

15. The remote printing service method according to claim 10, wherein the communication section of the communication terminal temporarily accumulates the printing subject data with the data format converted to the data format handled by the remote printing server in a printing spooler terminal, and
the registration request is executed to the remote printing server not directly but indirectly via the printing spooler terminal.

16. The remote printing service method according to claim 15, wherein the printing spooler terminal enciphers and transmits the accumulated printing subject data to the remote printing server.

17. The remote printing service method according to claim 11, wherein the communication terminal has the printing command quick response section store a file comprising a Web page in the printing subject storage section in the case a printing command of a Web page viewed is received from the user.

18. The remote printing service method according to claim 11, wherein an intermediate server is provided between the remote printing server and the communication terminal,
the intermediate server has: a base station position administering section administer base station position information showing the position of the wireless base station in the wireless local area network in the case the communication section of the communication terminal accesses to the remote printing server via a predetermined wireless local area network;
a printing terminal position administering section administer printing terminal position information showing the position of the printing terminal; and
the printing terminal guiding information reply section return to the communication terminal the printing terminal guiding information for guiding the user operating the communication terminal to the printing terminal corresponding to the printing terminal position information geographically close to the position shown by the base station position information of the wireless base station receiving the command in the case a registration request is executed from the communication section of the communication terminal, and
the communication terminal has the printing terminal guiding information providing section provide the printing terminal guiding information to the user.
